(19) United States
(12) Patent Application Publication
(10) Pub. No.: US 2014/0340283 A1
(43) Pub. Date: Nov. 20, 2014

(54) SYSTEM AND METHOD FOR DELIVERY AND INTEGRATION OF MULTI-SOURCED TARGETED INFORMATION ON REMOTE DISPLAY DEVICES

(71) Applicants: Andrew Steckley, Vancouver, WA (US); Daniel Richard Russell, Portland, OR (US)

(72) Inventors: Andrew Steckley, Vancouver, WA (US); Daniel Richard Russell, Portland, OR (US)

(73) Assignee: MAKAD ENERGY, LLC, Vancouver, WA (US)

(21) Appl. No.: 13/457,128

(22) Filed: Apr. 26, 2012

Related U.S. Application Data
(60) Provisional application No. 61/480,729, filed on Apr. 29, 2011.

(51) Int. Cl. G09G 5/00

(52) U.S. Cl. 345/2.1

(57) ABSTRACT

Method and system to provide personalized display data from a remote data site that can include personal data, public data, and targeted data in an integrated stream to a display device that is local to the user.

### RELATED APPLICATIONS

The present application claims the benefit of U.S. Provisional Patent Application Ser. No. 61/480,729 filed on Apr. 29, 2011, the complete disclosure of which is hereby incorporated by reference in its entirety and for all purposes.

### BACKGROUND OF THE INVENTION

Various channels exist that enable the delivery of information to large numbers of end-users—telephone, television, email, text messaging, and web-sites to name just a few. Some of these, such as email, lend themselves to a “push” based delivery in which those wishing to send the information can actively deliver it to those they wish to receive it. Other channels, such as some web-sites, are primarily suited to a “pull” based delivery in which it is necessary for the intended recipient to initiate the process of seeking and retrieving the information. This is true even when an advertisement is considered to be “pushed” by way of a pop-up window or an ad banner, since it is still necessary for the visitor to first visit the web-site.

In addition, the delivery of information may be specifically relevant to the recipient or it may be more generic. For example, the delivery of an advertisement via television is broadcast to all the viewers of the channel, but is likely of interest to only a small number of those viewers. Similarly a standard static web site presents the same information to any and all visitors to the web-site. Interactive web-sites, which make use of “cookies” or require visitors to login, attempt to go further by maintaining collateral data about each user, and then using that data to present information that is specifically relevant or “targeted” to them.

The ability to deliver such targeted information in the form of advertising is valuable to marketers as it typically provides them the lowest cost per customer acquisition. Marketers seek to entice web-site users to provide more data about themselves, or otherwise covertly gather data, that could be then used to improve the targeting of information presented to them on the web pages. Requiring entry of personal information in order to setup an account, offering surveys in exchange for services or coupons, and tracking user behavior and search engine queries have all been used extensively for this purpose.

There is a need for a method and system that provides high information delivery that is both targeted and pushed. As an example, a desirable situation for marketers is where they can deliver information that is not only targeted, but also pushed—that is, where they do not have to rely on the intended recipient to actively come and retrieve the information, but where the marketer can proactively deliver it. They can then target not only who to deliver it to, but when to deliver it.

### SUMMARY OF THE INVENTION

In general, embodiments of this disclosure provide a novel method and system for push-based delivery of information that is dynamic, targeted, and personalized from a data center to a display device located on a remote site.

In a first embodiment, a system is provided for delivery of information from a data center to a display device located at a remote site. The display device includes firmware for communication with the data exchange servers located at the one or more data centers in order to poll for new information to display, as well as for several other purposes. The display device firmware is responsible for periodically communicating with a data center to upload data and receive data as well as display data received from a data center. The data exchange server hosted on the data center transmits data exchange responses, including display information, to the display device.

Another embodiment provides a method for delivering targeted information from a data center to a selected display device. A display device disposed at the remote device is identified by a unique identifier, which a server hosted on the data center utilizes to derive targeting information for the display device. The server is further adapted to send respective display information to a selected display device.

### BRIEF DESCRIPTION OF THE DRAWINGS

FIG. 1 is a component schematic of an information delivery system according to an illustrative embodiment of the invention.

FIG. 2 is a component schematic of elements of the on-site display device according to an illustrative embodiment of the invention.

FIG. 3 is a component schematic of the firmware on the on-site display devices according to an illustrative embodiment of the invention.

FIG. 4 is a functional schematic showing data exchange communications for one illustrative embodiment of the system shown in FIG. 1.

FIG. 5 is a component schematic of another illustrative embodiment of the system shown in FIG. 1 with the addition of auxiliary interface applications and their users.

### DETAILED DESCRIPTION OF THE INVENTION

In the following detailed description, references are made to the accompanying drawings which form a part hereof, and in which are shown by way of illustration specific embodiments or examples. These embodiments may be combined, other embodiments may be utilized, and structural changes may be made without departing from the sprit or scope of the present invention. The following detailed description is therefore not to be taken in a limiting sense and the scope of the present application is defined by the appended claims and their equivalents.

Referring now to the drawings, in which like numerals refer to like elements through the several figures, aspects of an illustration of the present disclosure and an example of a computing operating environment will be described. In the description of operation that follows, hardware components may be described as performing various actions and functions. In such cases, it is understood that the action or function may in fact occur by firmware or software executing on a microprocessor component of the referenced hardware. For example, it may be described that the display device stores data in its data cache, but this actually occurs by the device firmware executing on the device microprocessor to realize the action. In this particular context, one can treat the term the device and the device firmware as equivalent. Similarly, it may be described that the data exchange server performs a particular function, but again it is understood that software executing on the data exchange server actually causes the function to be completed. Also in the description of operations that follow, communications between on-site display devices and data exchange servers may be described in terms of the conventional language of a client-server pair, wherein one side is the client that makes a request, and the other side is a server that returns a response. In such cases it is understood, that this relationship of client-server may be reversed, and either side may be making the initial response with the other side subsequently responding, so long as the effective result is the exchange of communication content.

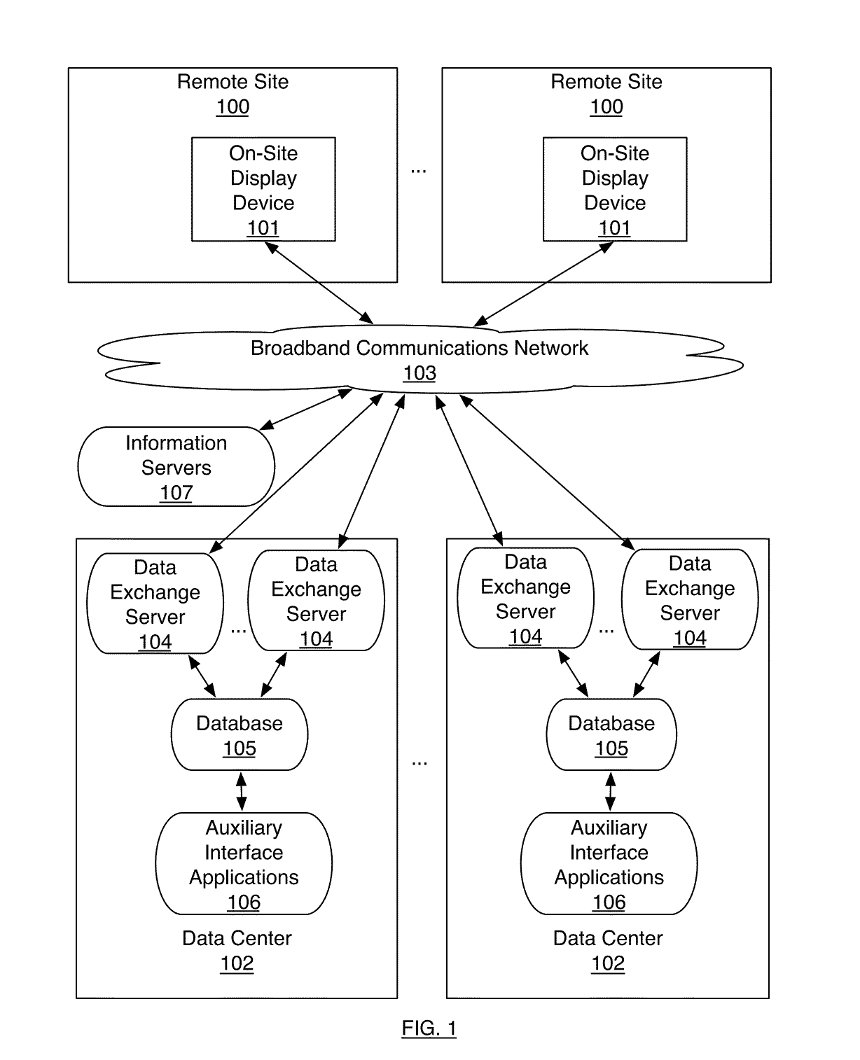

FIG. 1 shows an example of the overall system, including a plurality microprocessor-based on-site display devices (101) located at a plurality of remote sites (100); and one or more data exchange servers (104), a database (105), and possible auxiliary UI applications (106) that also access the database (105), all located at one or more data centers (102). There may be a plurality of remote sites, such as small-businesses, residential premises, or within mobile vehicles and vessels, and a plurality of data centers. Such one or more servers may be located at the same data center, or they may be hosted by independent parties and located at entirely different locations on the Internet. Each on-site display device (101) communicates through a broadband communications network (103) with one or more remote data exchanges servers (104) located in one or more data centers (102). Each on-site display device (101) may also communicate with other information servers (107) accessible through the broadband communications network (103). We note that communication exchanges may occur over any communication medium, including proprietary RF solutions, over telephone networks, cellular, PCS, local networks, wide area networks, and the like. Similarly, the communication protocol may be Internet Protocol (IP) or any other protocol that support the communication exchange needs of the system.

In the illustrative embodiment shown in FIG. 1, within each data center (102), there is one or more data exchange servers (104) responsible for handling the communication exchanges that are initiated by the display device between the device and a database (105) within each data center. Data in the database may include, by way of example, data measured by one or more remote devices and the status of the one or more remote devices. The data centers may also host one or more auxiliary interface applications (106) for managing data within a database (105) and for data center management of the overall network. The database at each data center may also include additional data regarding each remote site or about that site's occupants. This data may be used to identify which on-site display devices to target with certain information, or to personalize the content of the information displayed. The functions of the data exchange servers, the database, the auxiliary interface applications, and any other server functions may be disposed on a single piece of hardware, or on a separate piece of hardware for each function.

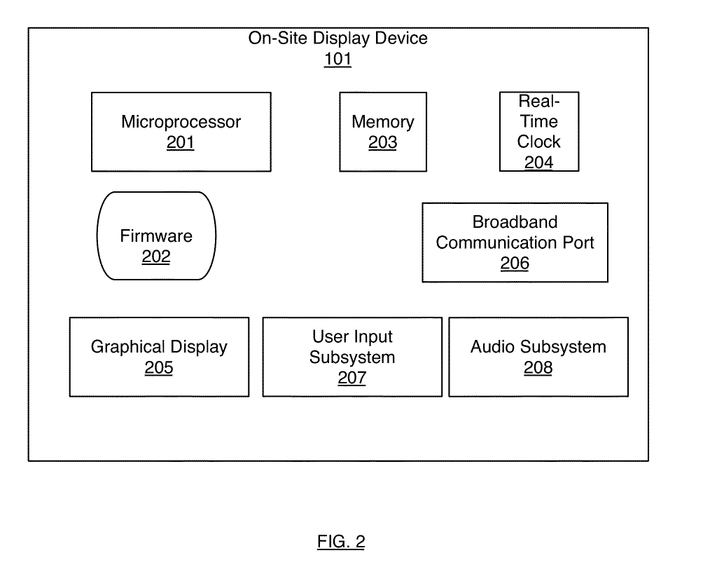

As shown in FIG. 2, an illustrative on-site display device includes a microprocessor (201), a firmware (202), a memory (203), a real-time clock (204), a graphical display, an user input subsystem, an audio subsystem, and peripherals including a broadband communication port enabling it to communicate on a broadband network for exchanging information with the data exchange servers located at the data center. In one embodiment, this communication port is an Ethernet port for TCP/IP based communication over a LAN, WAN, or public Internet. In yet another embodiment, the on-site display device may access the broadband communications network using IEEE 802.16 WiMax protocol, or other types of wireless communication protocol used to transfer data. A microprocessor (201) executes firmware (202) and accesses local memory (203) to perform various functions. These functions may include, for example, performing the communications through a broadband communications network (103), which is accessed through a broadband communications port (206), the displaying of information on the graphical display (205), and the processing of user input from the user input subsystem (207). A real-time clock (204) is used to provide accurate time and to maintain synchronicity with the data center, and to schedule the displaying of information on the graphical display (205). The on-line display device may also include an audio subsystem (208) by which sound may be emitted. Such sounds may be emitted in coordination with the information displayed on the graphical display (205) or for separate purposes such as alerting site-occupants. This disclosure refers to the on-site display device (101) functions of managing and displaying information, however, in an illustrative embodiment the on-site display device (101) is a general computing device and so may be used to perform additional functions, such as monitoring and control of remote devices, delivery of multi-media entertainment, or telephony services. Other functions, besides these examples, may also be performed by the on-site display device (101). One example of an on-site display device of an illustrative embodiment is a touch-screen tablet computer with WiFi Internet connection. In an illustrative embodiment, the display device includes a touch screen display to support user input. It may, however, include another form of user interface, such as a keypad. Or it may support only display of information to a user, without supporting any means of obtaining input from a user.

Referring back to the illustrative embodiment shown in FIG. 1, the information elements that are delivered to the on-site display devices are managed and maintained by servers in one or more data centers, and delivered to the on-site display devices via broadband communications. Each on-site display device will cycle through its own list of information elements, displaying the associated information for each one according to any display control parameters also included in the information element. Each of the plurality of on-site display devices maintains its own list of information elements, which it receives from servers in the data centers; however, the content of a particular list may be unique to the particular on-site display device, or some or all of the information elements in the list may be common to lists on other on-site display devices. Also different information elements in the list of information elements on a particular on-site display device may originate from different data centers. That is to say, a particular on-site display device may be in communication with multiple data centers and be receiving information elements related to different information sources from each one. For example, one data center may be providing information elements originating from a particular vertical market firm such as an electric utility, while another data center is providing information elements from a certain group of retail vendors. Yet another may only be providing information elements originating from external data feeds from public service sources.

A result of the above illustrative embodiment is that the populations of on-site display devices that separate data centers are in communication with and may constitute overlapping sets of on-site display devices, or mutually exclusive sets, or a combination of these situations. At the same time, the populations of data centers that separate on-site display devices are in communication with and may constitute overlapping sets of data centers, or mutually exclusive sets, or a combination of these situations.

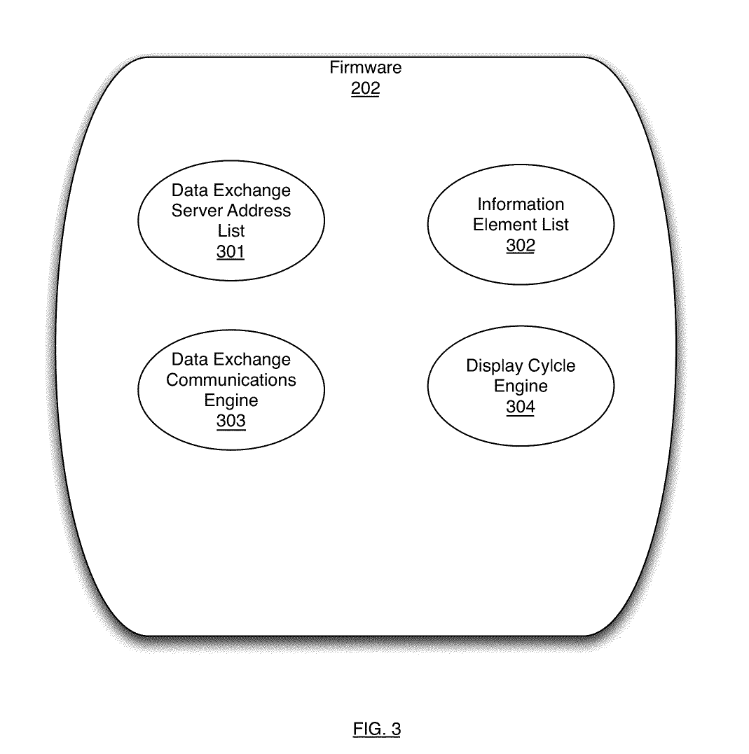

FIG. 3 shows a component schematic of an example of the firmware (202) of the on-site display device (101). FIG. 3 only includes primary components of the preferred embodiment of the firmware (202) that would be additional to a standard embedded computer for use as an on-site display device (101); such embedded computers also include other firmware components such as an operating system and drivers for peripherals such as a touch screen graphical display and communications ports. The firmware components described herein are meant to denote and distinguish logical divisions of functionality for the purposes of elucidating embodiments of the present disclosure and its constituents. In their practical realization, these various firmware components may be implemented in discrete source and binary code packages that are distinct and separable from each other; alternately, multiple such components may be implemented in one or more integrated code packages.

Referencing again FIG. 3, the firmware (202) includes two independent processing engines: a data exchange communications engine (303) and a display cycle engine (304). The engines may be implemented within a single logical process thread, or as separate synchronized processing threads. The data exchange communications engine (303) is responsible for making scheduled communication requests to one or more data exchange servers (104), for uploading data from the on-site display device (101) to the corresponding data center (102), and for retrieving data from the corresponding data center (102). The data retrieved may include various data for display, known as information elements, and various control directives.

In this illustrative embodiment, the on-site display device maintains a list of data exchange server addresses to contact. When initiating a data exchange request, the data exchange communications engine (303) references the data exchange server address list (301) for locating the data exchange servers to contact. One illustrative embodiment uses the Internet as the broadband communications network and the network addresses would be a Universal Resource Location (URL). In an alternate embodiment, using a modem pool, the list of network addresses would be a list of modem telephone numbers. These addresses may be modified in response to certain control directives received during the data exchange communications occurring between the on-site display device (101) and the data exchange servers (104).

Continuing to refer to FIG. 3, the display device firmware may also include a display cycle engine (304). The display cycle engine references an information element list containing at least one information element, which is stored locally on the on-site display device. In an illustrative embodiment, the display cycle engine cycles its display repeatedly through this list of information elements, displaying the information with each element according to any display control parameters also included in the information element and for a specified period of time.

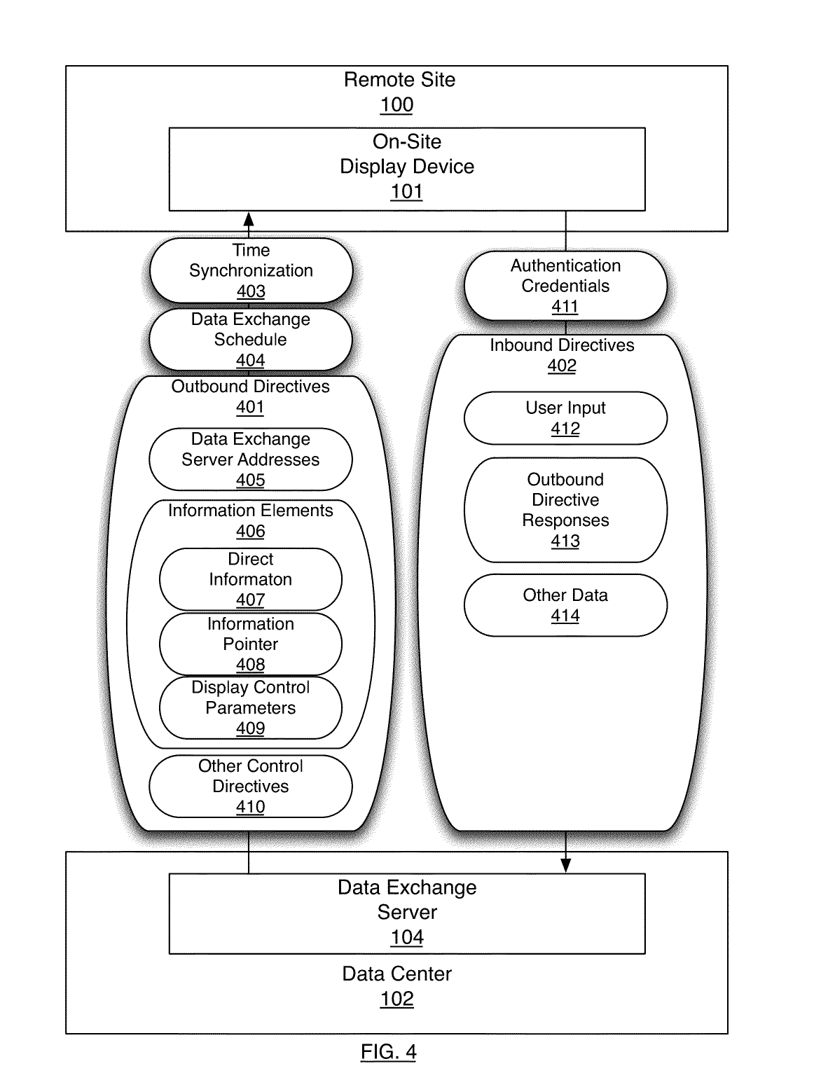

Referring now to FIG. 4, with reference to FIGS. 1 and 2, an illustrative embodiment utilizing a data exchange communication between the on-site display device and the data exchange server is described. When an on-site display device (101) located at a remote site (100) communicates with a data exchange server (104) located at a data center (102), this communication session my result in data being delivered in both directions. In this embodiment, the on-site display device initiates the data exchange communication with the data exchange server located at the data center, in order to poll for new information to display, as well as for several other purposes. The device firmware holds a data exchange server address list for locating the data exchange servers. For example, one embodiment uses the Internet as the broadband communications network and the network addresses would be a Universal Resource Location. The on-site display device initiates a communication session by transmitting a data exchange request, including authentication credentials and any data to be uploaded, up to the data exchange server through, for example, the broadband communications network. The display device retrieves all data that is to be delivered to the data center from a data cache. In an illustrative embodiment, the device attempts to send a data exchange request to the first server address on its list of data exchange server addresses. If that fails, the device will attempt to send its request to the second address, and so on. If all the attempts fail, then the device will return the data to the data cache, and then wait for a period of time equivalent to its currently configured data exchange schedule before repeating the process. With all the data that the device may be holding for upload to the data center still in the data cache, the device continues to execute its other functions, until the data exchange communication begins again. This illustrates one method according to the present disclosure that the device continues to manage its local environment and maintain data from that environment, even when its connection to the data center is unavailable.

Continuing to refer to FIG. 4, upon receiving a data exchange request from the remote on-site display, the data exchange server authenticates the request, and identifies the requesting on-site display device. A unique identification of a particular display device may, in one possible example, be based on the device's unique MAC address associated with its hardware. Or, alternatively, it may be based on any unique identifier that has been established in association with the device during its data exchange communication. The authentication step allows each side of the communication to verify that the other is part of the legitimate system and that each side is entitled to communicate with the other. Authentication may be accomplished by various means, including use of a pre-shared key, 802.1x certificates, and other methods known to those skilled in the art. Authentication credentials may be used to build an encrypted communication channel. If the data exchange server successfully validates the authentication credentials (411), it will then process any inbound directives (402), storing any associated data directly or in processed form in the database. Non-exclusive examples of inbound directives may include user input (412) resulting from site occupants interacting with the on-site display device (101), outbound directive responses (413) which provide status or other data pertaining to the processing of outbound directives (401) sent to the on-site display device (101) during previous communication exchanges, or other data (414) that the on-site display device (101) may have for upload to the data exchange server (104). The data that the display device may accumulate for upload may include information about the specific user interactions in response to the information that the device has displayed. It may also include logged data from the display device regarding its performance, communications, or history of what information was displayed when and for how long. Data accumulated by the display device that is related to, or originating from, other devices with which it might be communicating may also be included in the uploads.

Upon receiving and authenticating a data exchange request from the on-site display device, the data center server identifies the requesting on-site display. It then consults its local database to determine an appropriate data exchange response for delivery to that particular on-site display device. In this illustrative embodiment, the data exchange response includes: time synchronization (403), which is used to keep the on-site display device (101) synchronized with the data exchange server (104); a data exchange schedule (404) that specifies when the on-site display device (101) should next initiate a communications session with a data exchange server (104); and any outbound directives (401) retrieved from the local database that are pending delivery to the particular on-site display device (101).

Still referring to the example shown in FIG. 4, outbound directives (401) specify a variety of possible directives for the on-site display device (101) to process. They may include directives to modify the data exchange server address list (301) being used by the on-site display device (101) in which case the outbound directive (401) may include one or more data exchange server addresses (405) to be added to the data exchange server list (301). Outbound directives (401) may also include directives to modify the information element list (302) being used by the on-site display device (101) in which case the outbound directive (401) may include one or more information elements (406).

In an illustrative embodiment shown in FIG. 4, each such information element includes data to be displayed either in the form of: direct information (407), such as graphical images, textual data, or web-page content, to be displayed; or an information pointer (408) such as a Universal Resource Locators (URL), by which the on-site display device (101) may find and retrieve the direct information from remote servers. Such remote servers may be located at the same data center where the data exchange server is located, or they may be hosted by independent parties and located at entirely different locations on the Internet. The direct information acquired is then displayed on the device. Illustrative examples of direct information that may be displayed on the device may be targeted advertisements from retail stores, restaurants, or service providers. Or it may be public service announcements such as Amber alerts, neighborhood watch bulletins, or school closure information. It may also be more personal information for the site occupant, such as photos or configured information about stock prices or news feeds of interest, or data gathered from other devices and systems at the site, such as energy meters or environmental sensors. It may include other types and sources of information not mentioned here. In other embodiments, the information displayed may also be interactive; for example the site-occupant may input a simple acknowledgement of the information through a touch-screen or keypad. Or they may interact with the display device to order take-out food, purchase a product or service, or answer questions in response to an advertisement or survey being displayed on the screen.

Still referring to FIG. 4, each information element (406) may also include data, referred to as display control parameters (409), which further specify the display process that the on-site display device (101) will use to display the associated information. For example, control parameters include, but are not limited to, such factors as length of time to display the information, dates and times to begin and end displaying this information, scale factors for modifying the information content based on the size of the on-site display device, and parameters indicating whether and for how long to cache the content locally before refreshing it by retrieving it from the source indicated by the information pointer.

Outbound directives (401) may also include additional directives, referred to as other control directives (410) for the on-site display device (101), such as configuration directives. For example, other control directives in the data exchange response may include specifications for the display device to perform various functions, including the addition, removal, or updating of entries in its list of information elements or in its list of data exchange server addresses

Such directives may be targeted for a single specific on-site display, or for a whole group of on-site displays that meet some specific criteria. For example, the directive may specify the addition of an information element to the display device's list. That information element may be an advertisement for a particular restaurant and it may therefore be targeted for displaying on all on-site displays that are located at sites within a specified distance of the restaurant. Or it may be an advertisement for a particular service relevant to certain types of remote sites and therefore targeted to those on-site displays that have been correlated with that site type, regardless of their geographic location.

Referring still to the illustrative embodiment shown in FIG. 4, outbound directives (401), when processed by the on-site display device (101), may produce resulting data that is then delivered back to the data exchange server (104) in the form of temporally decoupled outbound directive responses (413). Together this pair of data transmissions completes a round trip command delivery, execution, and confirmation between data center (102) and on-site display device (101).

An example of a data exchange session between client and server is described in, U.S. patent application Ser. No. 12/567,798, filed Sep. 27, 2009, and entitled “System and Method for Intelligent Automated Remote Management of Electromechanical Devices” and incorporated by reference herein. It is to be appreciated that other approaches and architectures may be substituted. For example, alternative forms of communications between the display device and servers at the data center may be used. For example, in one embodiment, the connections may be initiated at the server side by the data exchange server. In yet another embodiment, the communication connections between the server and the display device may be also held continuously open.

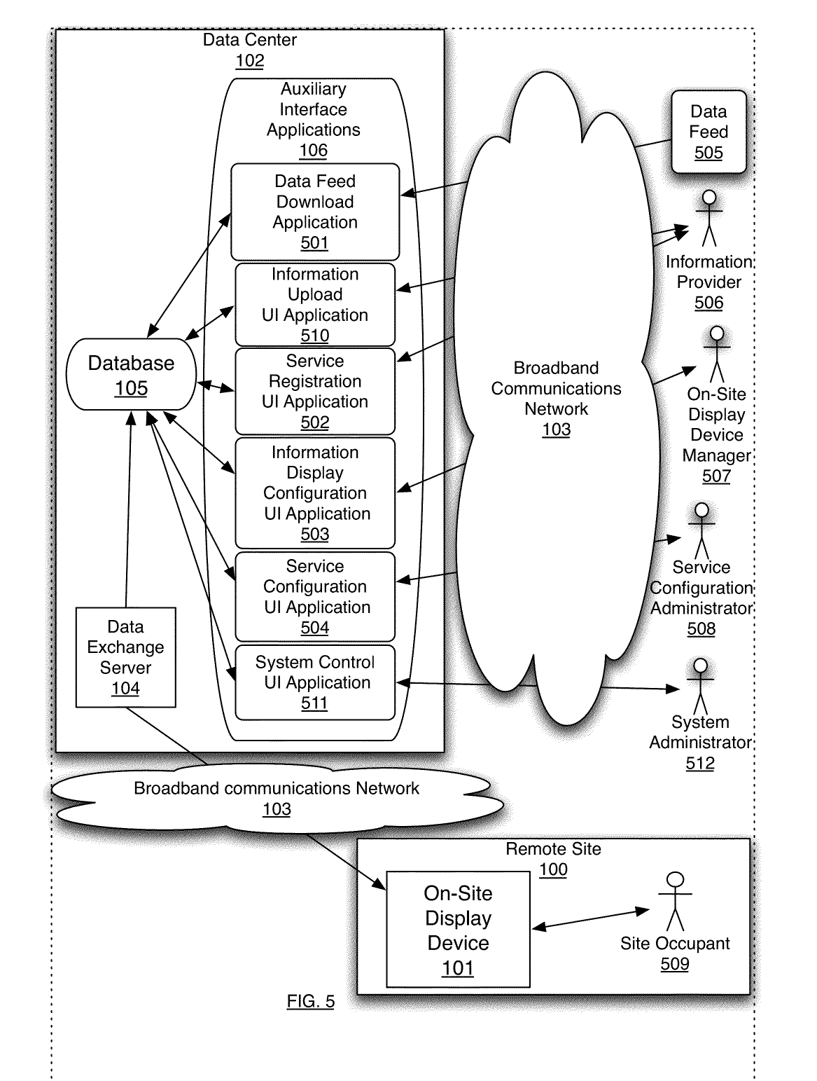

Referring now to FIG. 5, in an illustrative embodiment, one or more of the data centers host at least one auxiliary user-interface applications (106) that support the integration of multiple sources and types of information for displaying on an on-site display device (101). Non-exclusive examples include user-interface applications that enable: on-site display device owners or managers to select from available data services that can be delivered to their display device; third party entities to register the availability of their data services; third party entities to define, target, and schedule on-site displays or groups of on-site displays to receive specific information elements; and system administrators to also manage specific information elements as well as to configure and manage on-site display devices, associated end-user accounts, and various other aspects of the overall system. A site occupant (509) may, for example, wish the on-site display device (101) to cycle through a set of personal photo images, selected news feeds, and weather information. In addition, such site occupant (509) may want to know about real-time offers from a local merchant, or to receive certain text messages, or to be alerted with audio sounds along with certain visual information. All of these types of information elements (406) are retrieved from a database (105) in the data center (102) via a broadband communications network (103) such as the Internet. The mechanism to install, configure, and manage information elements (406) in the database (105), to be retrieved by the on-site display device (101), is through the auxiliary interface applications (106).

Some embodiments allow users to interact with one or more auxiliary interface applications at one or more data centers to import data from various external and internal services and data feeds, in order to process and deliver their associated information to on-site display devices. For example, such imported data may include two broad categories of information sources from which the current invention will derive information elements (406) for delivery to the on-site display devices (101). The first category of information sources are those from which information is actively downloaded from the source and then processed into suitable information elements (406) that may be delivered to certain on-site display devices (101). Non-exclusive examples include sources of information that are available independent of the present invention, such as pictures from an Internet picture hosting site, Amber Alerts from the U.S. Department of Justice, public service announcements, news sites, or weather data services. Other examples would include information developed by a vertical market firm, such as an electric Utility, that desires to offer energy-related data feeds (505) to site occupants (509) within the Utility's service territory. Such data feeds (505) are handled by the data feed download application (501).

The second category of information source are those that require information providers (506) to actively upload the information elements (406) to a data center (102), and generally do so because they have an interest in delivering the associated information to one or more on-site display devices (101). An example of an information source in this category would be a merchant who wishes to generate and deliver custom advertisements to site occupants (509) who are located near their retail location. Such information is uploaded by the information provider (506) and placed into the database (105) using the information upload UI application (510).

In an illustrative embodiment, another application, referred to as the data feed download application (501), downloads information through one or more data feeds (505), via a broadband communications network (103) such as the Internet. The data feed (505) may also be integral to the data center (102), such as user interaction information, or other data being generated or maintained within the data center (102).

In an illustrative embodiment, information providers (506) access a service registration UI application (502) through which they can register sources of information that may be provided for delivery to on-site display devices (101). Such information providers (506) can register data feeds (505) for download by the data feed download application (501), or they can register information elements they have uploaded via the information upload UI application (510), or a combination thereof.

In an illustrative embodiment, an information display configuration UI application (503) enables an on-site display device manager (507) to select and configure which of the available registered sources of information they wish to have delivered to the one or more particular on-site display devices (101) that they are responsible for managing. In another embodiment, some or all of this functionality provided by the information display configuration UI application (503) may be made available for access directly on the on-site display device (101).

In an illustrative embodiment, a service configuration UI application (504) is included to allow service configuration administrators (508) to configure the availability of registered sources of information. This activity may include, for example, configuring which of the registered sources of information are made available to which on-site display device managers (507) through the information display configuration UI application (503), and which are not. For example, an electric Utility information source may be configured such that it is only available to the on-site display device managers (507) for those sites that fall within that electric Utility's service territory. Or a merchant retailer source may be made available only to those on-site display device managers (507) whose sites are located within a specific geographic range of the retail store site. An information source may also be restricted to those sites who have purchased certain services or products related to the information source.

In an illustrative embodiment, a system control UI application (511) is included to provide system administrators (512) the capability to configure and manage various aspects of the overall system and to manage the population of remote on-site display devices (101).

Referring to the embodiment showing in FIG. 5 and discussed above, these various auxiliary user interface applications may be implemented as separate applications, or various combinations of them may be implemented together in a single application. Also, an on-site display device manager (507) may be the same person as the site occupant (509), or they may be different individuals. Similarly, the information provider (506), the service configuration administrator (508), and the system administrator (509) may be the same individual, different individuals, or any combination thereof.

This disclosure may include one or more independent or interdependent inventions directed to various combinations of features, functions, elements, and/or properties. While examples of apparatus and methods are particularly shown and described, many variations may be made therein. Various combinations and sub-combinations of features, functions, elements, and/or properties may be claimed in one or more related applications. Such variations, whether they are directed to different combinations or the same combinations, whether different, broader, narrower, or equal in scope, are regarded as included within the subject matter of the present disclosure.

The described examples are illustrative and directed to specific examples of apparatus and/or methods rather than a specific invention. Each of the various embodiments of the invention may have a different combination of elements. The invention is not limited to the specific embodiments disclosed, and may include different combinations of the elements disclosed or omission of some elements and the equivalents of such structures. Thus, any one of the various inventions that may be claimed based on the disclosed example, or examples, does not necessarily encompass all or any of particular features, characteristics, or combinations unless subsequently specifically claimed. Where “a’ or “a first” element or equivalent thereof is recited, such usage includes one or more such elements, neither requiring nor excluding two or more such elements. Further, ordinal indicators, such as first, second, or third, for identified elements are used to distinguish between the elements and do not indicate a required or limited number of such elements, and do not indicate a particular position or order of such elements unless otherwise specifically indicated.

1. A system for delivery of information from a data center to a display device that is located at a remote site, the system comprising:
a display device disposed at the remote site, the display device including a display device firmware adapted to initiate a plurality of data exchange communications with the center executed according to a data exchange schedule and each including a data exchange request transmitted to the data center and receive a data exchange response transmitted from the data center, wherein the data exchange responses each include at least one information element, the display device firmware being further adapted to display the each at least one information element; and
a server hosted on the data center, the server in communication with the display device firmware and adapted to transmit the data exchange responses to the display device, the server further adapted to determine the data exchange schedule and to transmit the data exchange schedule to the display device as part of one data exchange response.

2. A system as set forth in claim 1, wherein the each at least one information element includes: direct information to be displayed, an information pointer for direct information retrieval, or both.

3. A system as set forth in claim 2, wherein each information element further comprises:
at least one display control parameter for configuring the information element for display.

4. A system as set forth in claim 1, wherein the display device firmware is further adapted to locally store and manage a set of the information elements received from the data center.

5. A system as set forth in claim 3, wherein the display device firmware is further adapted to process each information element received, and display information on the display device according to the at least one display control parameter associated with the information element.

6. The system as set forth in claim 1, wherein the display device is adapted to temporarily store information to be displayed, whether included in the information element or retrieved from a location referred to in the information element.

7-9. (canceled)

10. The system as set forth in claim 1, further comprising a plurality of display devices including a first display device disposed within a first remote site and a second display device disposed within a second remote site, each adapted to communicate with the same server on the data center.

11. The system as set forth in claim 1, further comprising a plurality of the servers hosted on a plurality of the data centers including a first server and a second server, each adapted to communicate with the same display device.

12. The system as set forth in claim 1, further comprising:
a plurality of the servers hosted on a plurality of the data centers including a first server and a second server,
the first server adapted to at least one of:
communicate with the display device,
host a first database, and
support first user interface applications that enable creation and management of at least one information element, and
the second server adapted to at least one of:
communicate with the display device,
host a second database, and
support second user interface applications that enable creation and management of at least one information element.

13. A system as set forth in claim 1, comprising a plurality of display devices disposed within the same remote site, each display device adapted to receive separate and individually managed information elements.

14. A system as set forth in claim 1, wherein the display device further includes a plurality of hardware modules to receive input from a user at the remote site.

15. A system as set forth in claim 1, wherein the display device is adapted to collect data from a plurality of devices at the remote site over a plurality of local networks.

16. A system as set forth in claim 1, wherein the display device is adapted to store one or more locally collected data and is adapted to transmit the one or more locally data to the data center.

17. A system as set forth in claim 16, wherein the display device formats the locally collected data as information elements which are processed to generate information for display by the display device.

18. (canceled)

19. A system as set forth in claim 1, further comprising:
a display device identified by a unique identifier;
a server hosted on the data center, the server adapted to derive a plurality of targeting information for the display device identified by the unique identifier; and
the server further adapted to select a display device based on the targeting information.

20. A system as set forth in claim 19, the server further adapted to transmit a data exchange response to a plurality of display devices based on the contents of the targeting information.

21. A system as set forth in claim 19, the server further adapted to retrieve, process, and deliver information from external sources.

22. A method for delivery of targeted information from a data center to a display device that is located at a remote site, comprising:
establishing a data exchange communication with the display device;
receiving a first data exchange request from the display device, wherein the display device is identified by a unique identifier;
gathering targeting information for the display device identified by the unique identifier;
transmitting a first data exchange response to the display device, wherein the first data exchange response includes a data exchange schedule and information based on the targeting information;
receiving a second data exchange request from the display device; and
transmitting a second data exchange response to the display device, wherein the second data exchange response includes information based on the targeting information.

23. The method of claim 22, wherein transmitting a first data exchange response includes transmitting a first data exchange response to a plurality of display devices based on the contents of the targeting information, and wherein transmitting a second data exchange response includes transmitting a second data exchange response to a plurality of display devices based on the targeting information.

24. The method of claim 22, wherein the targeting information may be retrieved from external sources.

25. A display device for communication with a data center, the display device comprising:
a communication unit adapted to transmit a plurality of data exchange requests to the server and to receive a plurality of data exchange responses from the data center, each data exchange response including at least one information element; and
a display device firmware adapted to initiate a plurality of data exchange communications with the center executed according to a data exchange schedule transmitted during one of the data exchange responses, and each including one data exchange request transmitted to the data center and a corresponding data exchange response transmitted from the data center, the display device firmware being further adapted to display the each at least one information element.

26. A display device as set forth in claim 25, wherein at least one of the plurality of data exchange requests includes locally collected data.

27. A display device as set forth in claim 25, wherein the display device firmware is further adapted to locally store and manage a set of the information elements received from the data center.

28. The display device as set forth in claim 25, wherein the display device firmware is adapted to temporarily store information to be displayed, whether included in the information element or retrieved from a location referred to in the information element.
